(19) United States
(12) Patent Application Publication
(10) Pub. No.: US 2015/0206183 A1
(43) Pub. Date: Jul. 23, 2015

(54) METHOD AND SYSTEM FOR FACILITATING USERS TO OBTAIN CONTENT

(71) Applicant: Beijing Yidian Wangju Technology Co., Ltd., Beijing (CN)

(72) Inventors: Yushu Zhou, Beijing (CN); Zhaohui Zheng, Beijing (CN)

(73) Assignee: Beijing Yidian Wangju Technology Co., Ltd., Beijing (CN)

(21) Appl. No.: 14/404,397

(22) PCT Filed: Sep. 18, 2012
(86) PCT No.: PCT/CN2012/081528

§ 371 Date: Nov. 26, 2014

(51) Int. Cl. G06Q 30/02; G06Q 50/00

(52) U.S. Cl. CPC G06Q 30/0255; G06Q 50/01

(57) ABSTRACT

Methods, systems, and programming for facilitating users to obtain content are disclosed. In one example, a user is facilitated to create one or more channels each associated with an interest. Content is gathered for each of the one or more channels based on the interest associated with the channel. The content in each of the one or more channels is refined based on an interaction between the user and the channel. At least part of the content in each of the one or more channels is presented to the user. The presented content is determined based on relevance between each piece of content and the associated interest of the channel.

### BACKGROUND

1. Technical Field

The present teaching relates to methods, systems, and programming for Internet services. Particularly, the present teaching relates to methods, systems, and programming for facilitating users to obtain content.

2. Discussion of Technical Background

Current Internet users do not have efficient methods to discover, manage, and share content that they are interested in. Users mainly rely on news portals, search engines, social media, RSS readers, and social bookmarking services to receive, manage, and discover content. However, the known solutions have the following drawbacks:

First, there is no efficient way to automatically retrieve, discover, and push content based on users' interests. Current systems mainly fetch information by users' queries or by following information sources. For search engines, although search queries may reflect users' information needs and interests, users cannot save queries to get pushed, high-quality and personalized content automatically. Single query is applied to reflect users' interests by search engines, which often causes confusion and misunderstanding and also lack of expressive. Search engines cannot reflect users' long-term and steady interests. Also, while users can obtain information directly from the sources that they follow, such as a blog, a news portal, a friend on social media, or a RSS feed, this communication model has three main drawbacks:

(1) Unstable information retrieve. Despite of active information selection, users barely have controls on what information they can receive. For example, although a user subscribes specific information sources in order to get content about a topic, there is no guarantee that the user will get satisfying content. Information providers can easily stop information production or change their content without negotiating with their audiences. Especially in Web 2.0 era when ordinary people become information providers, these citizen content providers do not have the responsibilities to keep the high-quality and stable information production.

(2) Information duplication. For most of social media and RSS sources, there is no efficient third-party mechanism to balance information ecology. In order to get more attention from audiences, the Matthew Effect occurs in the communication field. That is, online content providers, especially in social media, are simply recyclers of the same top websites that consume up to most of the web traffic.

(3) The more sources the users subscribe, the lower quality information they may get. Since most of RSS readers and social media do not have an efficient way to rank information based on quality. Therefore, the more sources the users subscribe, the noisier the information they may get, and higher cost they would find satisfying information.

Second, content discovery, collection, and sharing are separated from each other by known solutions. Although people consume, save, and share content should be a natural process, it is cut apart online by known solutions. Normally, users rely on search engines or portals to get and discover content, but collect and save content by other tools or websites, yet share them to other social media. Such separation greatly increases users' task complexity and makes information management more difficult.

Therefore, there is a need to provide an improved solution for facilitating users to discover, organize and share content they are interested in order to solve the above-mentioned problems.

### SUMMARY

The present teaching relates to methods, systems, and programming for facilitating users to obtain content.

In one example, a method, implemented on at least one machine each of which has at least one processor, storage, and a communication platform connected to a network for facilitating users to obtain content, is disclosed. A user is facilitated to create one or more channels each associated with an interest. Content is gathered for each of the one or more channels based on the interest associated with the channel. The content in each of the one or more channels is refined based on an interaction between the user and the channel. At least part of the content in each of the one or more channels is presented to the user. The presented content is determined based on relevance between each piece of content and the associated interest of the channel.

In another example, a method, implemented on at least one machine each of which has at least one processor, storage, and a communication platform connected to a network for facilitating users to obtain content, is disclosed. An input from the user indicating one or more explicit interests is received. Information related to the user is collected. One or more implicit interests are identified based on the collected information related to the user. The user is facilitated to create one or more channels each associated with at least one of the explicit and implicit interests.

In still another example, a method, implemented on at least one machine each of which has at least one processor, storage, and a communication platform connected to a network for facilitating users to obtain content, is disclosed. A plurality of users are facilitated to create a plurality of channels each associated with an interest. At least some of the plurality of channels are connected to form an interest network. The connected channels are associated with interests that are related to each other. One or more advertisers are facilitated to deliver advertisements to the interest network based on the associated interests.

In a different example, a system for facilitating users to obtain content is disclosed. The system comprises a channel initiating module, a content gathering module, a content refining module, and a content presenting module. The channel initiating module is configured to facilitate a user to create one or more channels each associated with an interest. The content gathering module is configured to gather content for each of the one or more channels based on the interest associated with the channel. The content refining module is configured to refine the content in each of the one or more channels based on an interaction between the user and the channel. The content presenting module is configured to present at least part of the content in each of the one or more channels to the user. The presented content is determined based on relevance between each piece of content and the associated interest of the channel.

In another example, a system for facilitating users to obtain content is disclosed. The system comprises an interest grouping unit, an interest discovering unit, and a channel creating unit. The interest grouping unit is configured to receive an input from the user indicating one or more explicit interests. The interest discovering unit is configured to collect information related to the user and identify one or more implicit interests based on the collected information related to the user. The channel creating unit is configured to facilitate the user to create one or more channels each associated with at least one of the explicit and implicit interests.

Other concepts relate to software for facilitating users to obtain content. A software product, in accordance with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for facilitating users to obtain content, wherein the information, when read by the machine, causes the machine to perform a series of steps. A user is facilitated to create one or more channels each associated with an interest. Content is gathered for each of the one or more channels based on the interest associated with the channel. The content in each of the one or more channels is refined based on an interaction between the user and the channel. At least part of the content in each of the one or more channels is presented to the user. The presented content is determined based on relevance between each piece of content and the associated interest of the channel.

In another example, a machine readable and non-transitory medium having information recorded thereon for facilitating users to obtain content, wherein the information, when read by the machine, causes the machine to perform a series of steps. An input from the user indicating one or more explicit interests is received. Information related to the user is collected. One or more implicit interests are identified based on the collected information related to the user. The user is facilitated to create one or more channels each associated with at least one of the explicit and implicit interests.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts exemplary components associated with an interest channel, according to an embodiment of the present teaching;

FIG. 2 depicts exemplary interest channels created by a user and followed by followers, according to an embodiment of the present teaching;

FIG. 3 depicts an exemplary interest network composed of a plurality of interest channels created by different users, according to an embodiment of the present teaching;

FIG. 4 is a high level exemplary system diagram of a system for facilitating users to obtain content, according to an embodiment of the present teaching;

FIG. 5 is a flowchart of an exemplary process of the system for facilitating users to obtain content, according to an embodiment of the present teaching;

FIG. 6 is a system diagram for an exemplary channel initiating module of the system for facilitating users to obtain content, according to an embodiment of the present teaching;

FIG. 7 is a system diagram for an exemplary interest discovering unit of the channel initiating module, according to an embodiment of the present teaching;

FIG. 8 is a flowchart of an exemplary process of the channel initiating module, according to an embodiment of the present teaching;

FIG. 9 is a system diagram for an exemplary content gathering module of the system for facilitating users to obtain content, according to an embodiment of the present teaching;

FIG. 10 is a flowchart of an exemplary process of the content gathering module, according to an embodiment of the present teaching;

FIG. 11 is a system diagram for an exemplary channel sharing module of the system for facilitating users to obtain content, according to an embodiment of the present teaching;

FIG. 12 depicts an exemplary networked environment in which the present teaching is applied, according to an embodiment of the present teaching; and

FIG. 13 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of facilitating users to obtain content. The method and system as disclosed herein is capable of allowing users to create channels to categorize individuals' information interests in order to facilitate users to better discover content that users are interested in, manage information, and form better interest-based social interaction. The channels may be used as content discover platforms where users input their information interests and receive personalized content. The channels may be used as content collection platforms where users save and categorize the content. Moreover, the channels may be used as interest-based social interaction platforms that connect people with similar interests.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

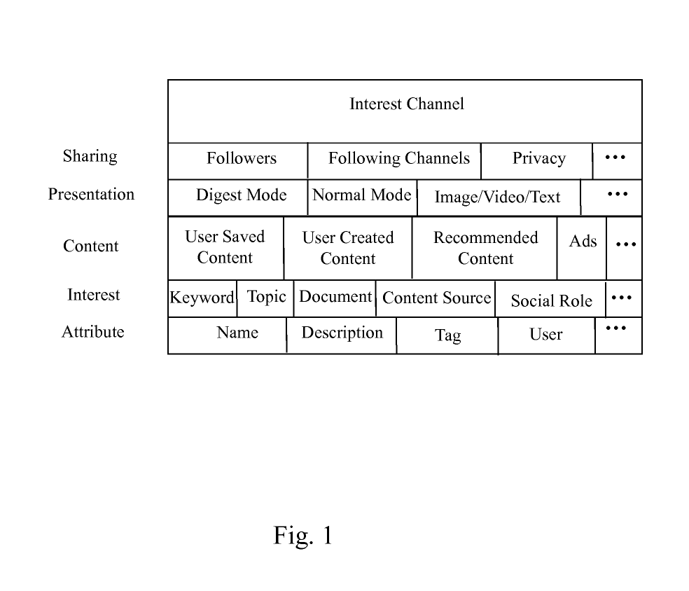

FIG. 1 depicts exemplary components associated with an interest channel, according to an embodiment of the present teaching. The components include, but are not limited to, attribute, interest, content, presentation, and sharing. The attribute, in this example, includes channel name, channel description, user created the channel, tags of the channel, or any other suitable attribute associated with a channel. For example, users may generate channel names and descriptions, which reflect user's interests and help the system better discover content. Once users change the channel names or descriptions, the content may be changed as well. As different users may create channels with the same or similar name or description, each channel may be also labeled by the user who created the channel.

Interests of the channel may be explicitly and directly expressed by, for example, keywords, topics/categories, exemplary documents, content sources (e.g., EPSN, CNN, etc.), persons, brands, entities, social account identifications (e.g., account name/id of FACEBOOK, TWITTER), interest tags in social accounts, Wikipedia entries (i.e., disambiguated concept words), social roles, demographics, etc. As each channel is created to facilitate a user to obtain content that the user is interested in, interests associated with the same channel may be related to each other. For example, for a channel with the name of “Soccer,” the associated interests may include keywords such as, “soccer” or “UEFA champions league,” content sources such as “ESPN soccer channel,” entities such as “AC Milan Club,” or persons such as “Messi.” The details of identifying and grouping interests for each channel will be described later.

The content in the channel may be obtained through various means. For example, users may save and categorize any content into the channels. When users consume content in the channels, they may save them in the channels. When the users consume content out of the system, they may also save content into the channels with any suitable extension tools. Also, users may create their own content in the channels, for example, by uploading images/video or writing articles. Based on the interests associated with a channel, the system may automatically gather content from various content sources and recommend them in the channel. In addition, as the channel represents user's strong and long-term information demands, which is highly correlated with the users' acceptance of advertisements, advertisements may be distributed into the channel based on the interests associated with the channel as part of the content in the channel.

The presentation component defines the manner in which the content in a channel is presented to its user or followers. Content may be organized and presented based on user interests. Various predefined presentation modes, such as normal mode or digest mode may be available for the user to choose based on the user's personal preference and/or other conditions, e.g., timing, location, system capacitate, etc. The details of the presentation modes will be described later. In addition, users may also customize features of presentation, such as adjusting the presentation format, e.g., image, video, text, background, font, etc.

The channels may be used as interest-based social interaction platforms that connect people with similar interests. Accordingly, the sharing component may include followers of the channel and other user's channels that are followed as they share the similar interests. Privacy control may be also part of the sharing component for determining the level of privacy of the content in the channel and for the following permission. It is understood that, although not shown in FIG. 1, any other suitable components or characteristics may be associated with the channels in order to facilitate users of the channels to better discover, organize and share content through the channels.

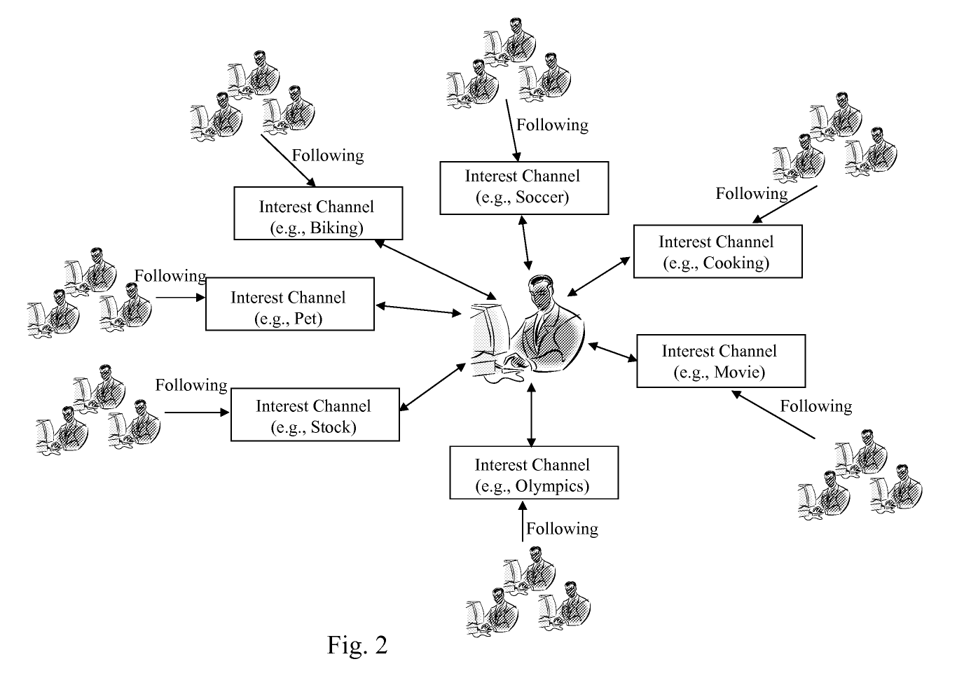

FIG. 2 depicts exemplary interest channels created by a user and followed by followers, according to an embodiment of the present teaching. Each user may create multiple channels each associated with one or more interests such that the user may follow everything she/he is interested in through a corresponding channel. In this example, the user creates a “Soccer” channel, a “Cooking” channel, a “Movie” channel, an “Olympics” channel, a “Stock” channel, a “Pet” channel, and a “Biking” channel. Other users (followers) then may choose to follow one or more of the channels created by the user based on the interests associated with each channel. Different from known social media platforms, where followers have to follow a specific user even though they may be interested in only a specific topic/category of content of that user, the followers in this example have the flexibility to follow one or more specific channels of a particular user by their shared interests.

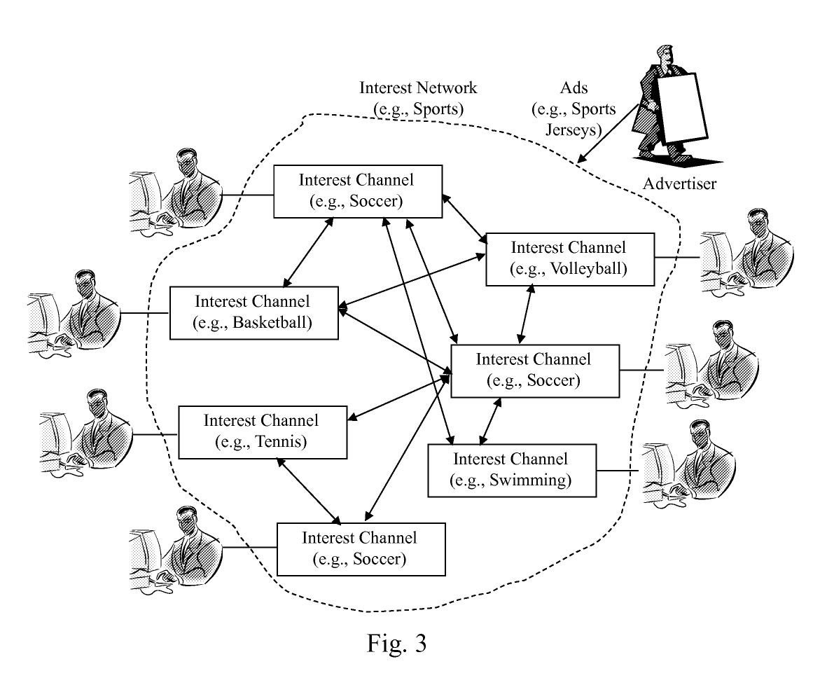

FIG. 3 depicts an exemplary interest network composed of a plurality of interest channels created by different users, according to an embodiment of the present teaching. Based on the shared interests, interest channels created by different users may be connected to form an interest network in this example. In other words, the channels are used as interests-based social interaction platforms that connect people with similar interests. In this example, all the channels with associated interests related to “Sports” (e.g., “Soccer,” “Volleyball,” “Swimming,” “Tennis,” “Basketball”) may be connected together to form a “Sports” interest network.

The interest network formed by interest channels may significantly improve the precision, coverage, arriving rates, and user satisfaction of advertising. Compared with the traditional online advertising method which relies on users' keyword search, social networks, and users' online behaviors, the interest network is built based on users' explicit interests. Such interests are also explicitly and directly expressed by a set of keywords, source preferences, networks built on following interest channels, and clicking behaviors. The system creates precise and more comprehensive user interest profiles or context. Without the need of arbitrary keyword expansion for advertising, advertisements may be distributed according to the explicit combination of interests, keywords, behavior, and feedback instead of a single query.

Moreover, different from conventional social media, such as FACEBOOK, the network in this example is built on users' interest profiles. Each person has multiple interest channels, and each channel is socially connected with other users based on shared interests instead of vague social relationships or geographic factors. In other words, channels represent users' strong and long-term information demands, which is found to be highly correlated with users' acceptance of advertisements. Therefore, distributing advertisements in interest-based online networks can significantly improve arriving rates and user satisfaction of advertising. In this example, advertisers may be encouraged to deliver advertisements of sport jerseys to each channel of the “Sports” interest network as the users of those channels are more likely interest in purchasing sport jerseys.

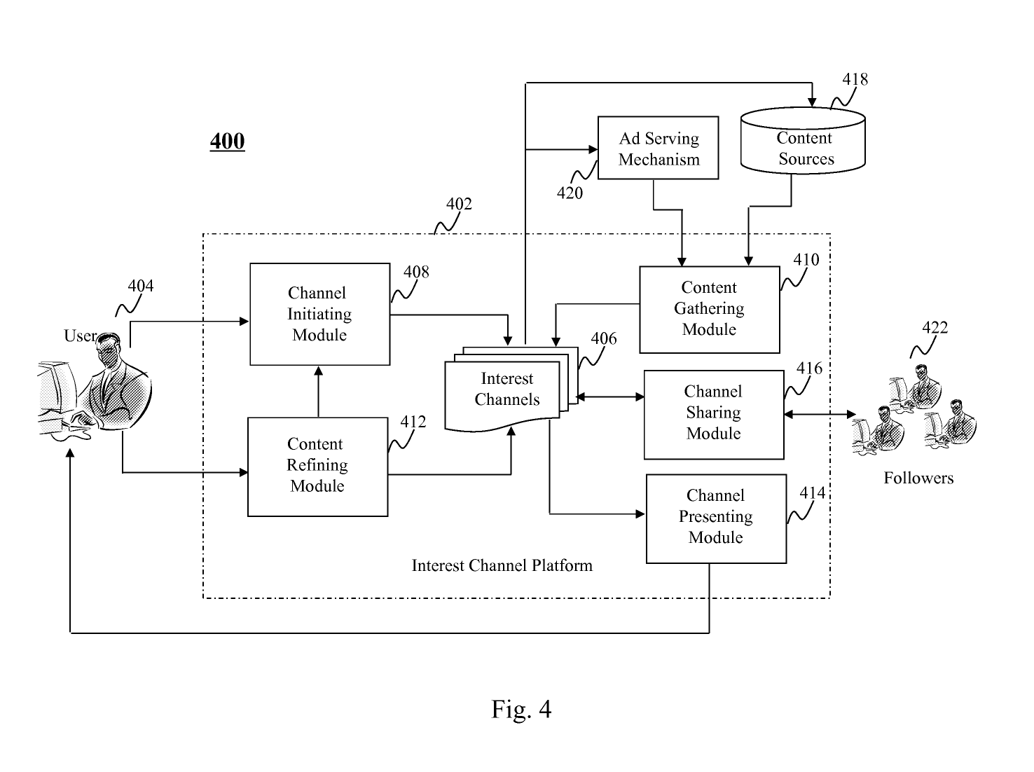

FIG. 4 is a high level exemplary system diagram of a system for facilitating users to obtain content, according to an embodiment of the present teaching. The system 400 includes an interest channel platform 402 for facilitating a user 404 to discover, collect and share content through one or more interest channels 406. The interest channel platform 402 in this example includes a channel initiating module 408, a content gathering module 410, a content refining module 412, a channel presenting module 414, and a channel sharing module 416. In general, the interest channel platform 402 facilities the user 404 to input her/his information interests and group them to different channels 406 and automatically discovers, personalizes, and presents a content flow for the user 404 through the channels 406.

The channel initiating module 408 in this example is configured to facilitate the user 404 to create one or more channels 406 each associated with an interest. The content gathering module 410 is responsible for gathering content for each channel 406 based on the interest associated with the channel 406. That is, the interest channel platform 402 assists the user 404 to follow everything she/he is interested in, such as keywords, topics, persons, brands, entities, social account identifications, interest tags in social accounts, Wikipedia entries, social roles, demographics, etc., and discover relevant information based on the interests for the users 404. In this example, the content may be gathered by the interest channel platform 402 from various internal or external sources, such as outside content sources 418 and an advertisement serving mechanism 420 for distributing interest-targeted advertisements to the corresponding channels 406. The content refining module 412 in this example is configured to refine the content in each channel 406 based on an interaction between the user 404 and the channel 406. The interaction may include, for example, changing of the interests associated with the channel 406, changing of the content in the channel 406, changing of the attributes associated with the channel 406, and social behaviors such as following a channel created by another user. The content refinement may be performed in a dynamic and continuous manner. In this example, the channel presenting module 414 is configured to present at least part of the content in each channel 406 to the user 404. The presented content may be determined based on relevance between each piece of content and the associated interest of the channel. Content may be organized and presented based on user interests. For example, in one channel, the channel presenting module 414 not only presents news, articles, but also present photo galleries, videos, discussions, ads, social feeds, and people with similar interests to users. The channel sharing module 416 in this example is responsible for facilitating other users (followers) 422 to follow the channels 406 based on the interests associated with the channels 406.

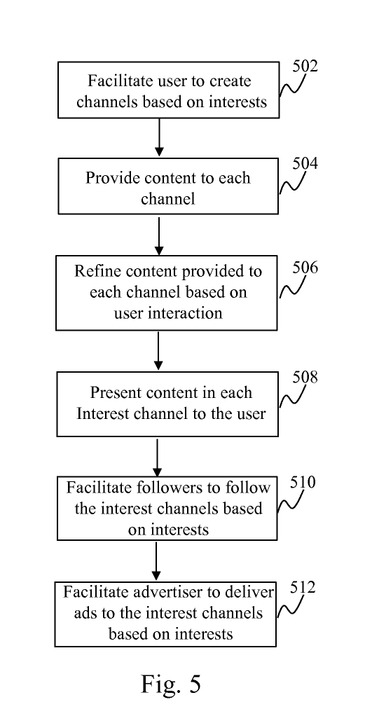

FIG. 5 is a flowchart of an exemplary process of the system for facilitating users to obtain content, according to an embodiment of the present teaching. Starting from block 502, users are facilitated to create channels based on their interests, for example, by the channel initiating module 408. The interests may be defined in various forms, such as but not limited to, keywords, topics/categories, content sources, exemplary documents, persons, entities, brands, social account identifications, interest tags in social accounts, Wikipedia entries, social roles, demographics, etc. The interest may be explicitly inputted by the users and/or identified and recommended to users by the interest channel platform 402 based on the user's profile and online behavior. In other words, channels may be created by the users in a hybrid fashion by taking advantage of both machine intelligence and user wisdom. In one example, users may define channels based on keywords. For example, users may type in one or more keywords to describe/define a channel, or the interest channel platform 402 may automatically recommend a few keywords to add to a channel based on user profile and the keywords that the user has already inputted for the channel. The interest channel platform 402 may also extract keywords from any user-related documents, such as articles or comments written or browsed by the users, and recommend them to the users. In another example, users may define channels based on topics/categories. For example, users may select one or more predefined topics/categories for a channel or select one or more topics/categories which are automatically generated by any known topical modeling approaches such as Latent Dirichlet Allocation (LDA). In still another example, users may define channels based on exemplary documents. For example, the users may label a few exemplary documents or segments of documents for each channel. In yet another example, the interests may be determined based on other users' channels that have been followed. For example, users can connect their social accounts to the interest channel platform 402, and the interest channel platform 402 may automatically understand users interest tags from their social accounts and create channels for them. In yet another example, the interest channel platform 402 may use short surveys or questions to understand users' social roles, which facilitates creating interest channel.

Moving to block 504, content is provided to each channel based on the interests associated with each channel, for example, by the content gathering module 410. The content may be automatically fetched by the content gathering module 410 from internal or external content sources based on the interests associated with the channel in a continuous or periodic manner. Users may also be facilitated to create and/or save content and categorize them into channels. At block 506, content in each channel is refined based on user interaction, for example, by the content refining module 412. In other words, users may participate in refining content in the channels. In one example, users may add or detect interests in the channels to help the interest channel platform 402 to change their content discovery/gathering strategies. In another example, users may change attributes, such as channel name, tags, or description, which may also help the interest channel platform 402 to update its content discovery/gathering strategies. In still another example, users may remove content that they are not interested in so that the interest channel platform 402 may better understand the users' preference and refine content accordingly. In yet another example, users may follow other user's channels. That is, content-based social interaction and social networks formed on the following channels may be used to refine content in the channels. In yet another example, all reading behaviors, such as read/unread, clicks on recommended topics/keywords, bookmarking and commenting behaviors may also be used to refine content.

Moving to block 508, content in each channel is presented to the user, for example, by the channel presenting module 414. Content may be organized and presented based on user interests. For example, in one channel, the channel presenting module 414 not only presents news, articles, but also present other information format such as photo galleries, music, videos, discussions, ads, social feeds, and people with similar interests to users. The interest channel platform 402 may select and present the content that is the most personally important and relevant to the user's interests associated with the channel. In one example, the content may be presented to the user in a digest mode. The digest may be completely updated periodically, e.g., daily, like issuing a new personal magazine each day. For example, in a one-day period, the content is dynamically expanded. The content in this mode may be automatically refreshed when the user accesses the channel, which may trigger the interest channel platform 402 to reorganize the content in this mode, so as to enable the user to consume newest and the most important information. All content may be archived periodically, e.g., daily, to make a personalized daily digital magazine, and the user may review the content based on the timeline so that the user can have a personalized information world only created around their interests.

At block 510, followers are facilitated to follow the channels based on the interests associated with each channel, for example, by the channel sharing module 416. The user and followers may comment or interact with the content, for example, by bookmarking, liking/disliking, forwarding, voting, etc. The user may apply privacy control to each piece of content in the channel so that certain content may be private to the user only or open to a group of followers. At block 512, advertisers are facilitated to deliver advertisements to the channels based on the interests associated with the channels. As mentioned above, a user may be precisely described by multiple interest channels, and each channel may be well defined with a combination of keywords, preferences, interest networks and behaviors. Therefore, the interest channel platform 402 may improve the precision, coverage, arriving rate, and user satisfaction of advertising.

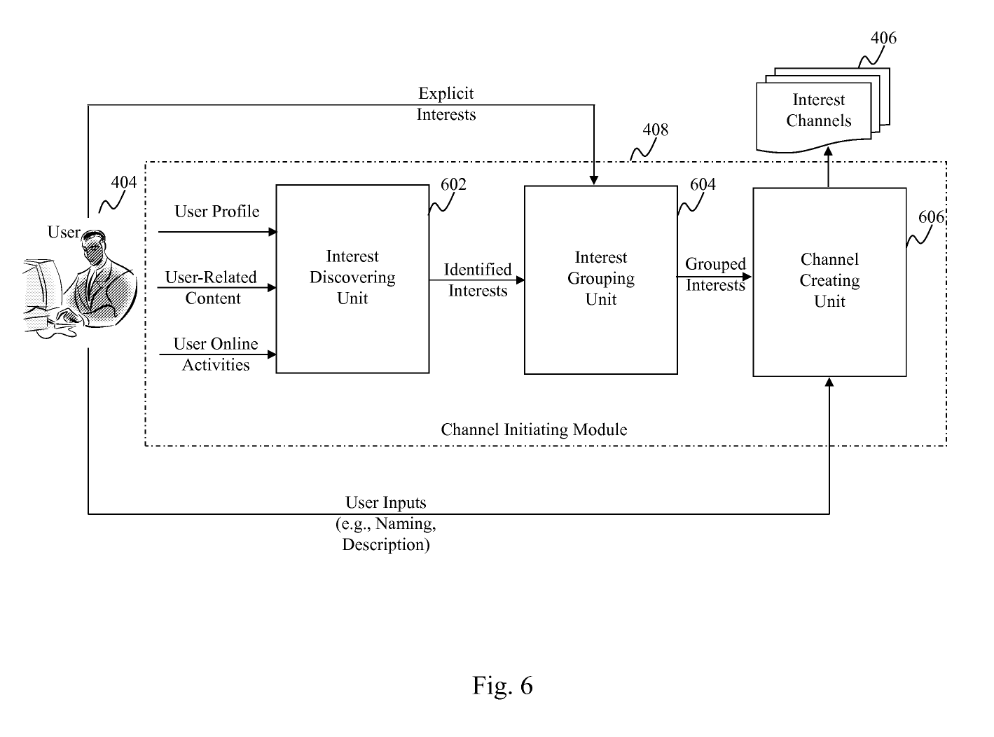

FIG. 6 is a system diagram for an exemplary channel initiating module 408 of the system for facilitating users to obtain content, according to an embodiment of the present teaching. The channel initiating module 408 in this example includes an interest discovering unit 602, an interest grouping unit 604, and a channel creating unit 606. The interest discovering unit 602 is configured to collect information related to the user 404 and identify one or more implicit interests based on the collected information related to the user 404. The information related to the user includes, for example, user profile, user-related content, such as articles or links created or consumed by the user, and user online activities. The interest discovering unit 602 disclosed herein may be implemented using a wide range of information filtering techniques that predict an interests that a user would have in online content using any suitable model built based on the characteristics of users and the content related thereto and the user's online behaviors. One example is disclosed in corresponding PCT Patent Application No. PCT/CN2012/072495, having a title “METHOD AND SYSTEM FOR RECOMMENDING CONTENT TO A USER,” which is incorporated herein by reference.

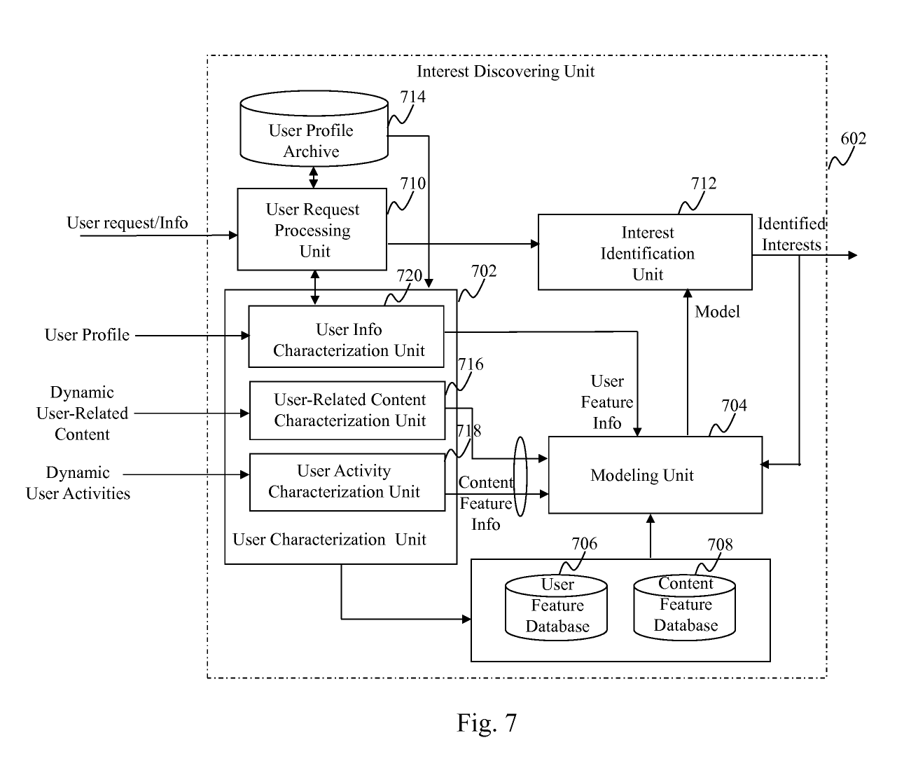

Referring now to FIG. 7, in this example, the interest discovering unit 602 is configured to obtain information related to the user, whether such information is static, dynamic, explicit or implicit, and identify one or more topics of interest for the user based on a model that maps from users to topics of interest. The model is established based on information related to the existing users of the interest channel platform 402. In some embodiments, for a new user who just signed up to the system, basic attributes of the new user, such as age, gender, profession, residency, etc., is sufficient for the interest discovering unit 602 to identify implicit interests based on the recommendation model. In other embodiments, for an existing user, every time when the existing user signs in the system, the interest discovering unit 602 is able to identify up-to-date implicit interests based on the continuously refined recommendation model and/or the dynamically refreshed user information and online behaviors. In still other embodiments, new users may use their social accounts (such as FACEBOOK, TWITTER) to sign up, and the system may automatically retrieve and discover their interests according to their social accounts. For example, users can connect their social accounts to the interest channel platform 402, and the interest channel platform 402 may automatically understand users interest tags from their social accounts and create channels for them. When users connect their social accounts to the interest channel platform 402, the interest channel platform 402 understands and fetches users' interests via the posts, tags, descriptions, and other content on users' social accounts.

The interest discovering unit 602 in this example includes a user characterization unit 702, a modeling unit 704, a user feature database 706, a content feature database 708, a user request processing unit 710, an interest identification unit 712, and a user profile archive 714. The user characterization unit 702 in this example includes three units, each of which is responsible for processing one type of input dynamic user information. The dynamic user-related content and user activities are characterized by the user-related content characterization unit 716 and the user activity characterization unit 718, respectively, and are converted to content feature information, including topics/categories and keywords (e.g., represented by a content feature matrix B). The user profile (user attributes) is characterized and converted to user feature information (e.g., represented by a user feature matrix A) by the user information characterization unit 720. Both the user and content feature information are fed into the modeling unit 704 to generate a recommendation model for the interest identification unit 712. Each new user, upon signing-up to the interest channel platform 402, may provide basic user profile through the user request processing unit 710. Thus, user profiles may be also obtained by the user characterization unit 702 from the user profile archive 714 where profiles of all existing users are kept.

The modeling unit 704 in this example is configured to establish a model that maps from users to topics of interest based on the user and content feature information fed from the user characterization unit 702. In this example, the model may be established based on a user feature matrix A representing user features with respect to the existing users and a content feature matrix B representing content features with respect to the existing users. The user feature and content feature database 706, 708 may store a larger amount of information related to user attributes, topics, and keywords, as compared with the user and content feature information used by the modeling unit 704 to establish or refine the model. The information to be fed to the modeling unit 704 may be selected in a manner to reduce the dimension of matrix A or matrix B in order to be computationally competitive. Such selected information may be the most relevant at the time of the selection. Due to the fact that interests or context of user's environment may change over time, other collected data is still stored so that when needed, certain information can be retrieved and used when, e.g., the model needs to be drastically refined. For example, over time, a user's interest may change. It is understood that the dimension of the content feature matrix B is usually reduced because of the large amount of keyword data. As to the user feature matrix A, whether the dimension reduction should be performed is a design choice made case by case.

The user request processing unit 710 in this example is responsible for collecting a new or existing user's basic attributes when receiving a request to identify implicit interests of a user (e.g., when a new user first time signs-up to the interest channel platform 402 or an existing user signs in the interest channel platform 402). The user request processing unit 710 in this example may perform attribute preprocessing and normalization operations to generate a user feature vector for each user when they first time sign up or every time when they update their attributes. For example, for certain user attributes, the user request processing unit 710 may convert them to appropriate categorical feature(s) based on the correlation of its values with content interests. The user profiles may be saved in the user profile archive 714 for future use.

The interest identification unit 712 in this example is configured to provide estimated topics of interest for new or existing users based on the recommendation model from the modeling unit 704 and the user profile (e.g., feature vector) obtained from the user request processing unit 710. The estimated topics/implicit interests may be provided to the interest grouping unit 604. In addition, the estimated topics may be continuity fed back to the modeling unit 704 for model refinement.

Referring back to FIG. 6, the interest grouping unit 604 in this example is configured to receive an input from the user 404 indicating one or more explicit interests and receive implicit interests identified by the interest discovering unit 602. The interest grouping unit 604 is also responsible for facilitating the user 404 to group the explicit and implicit interests into the one or more channels. The user input of the explicit interests includes, for example, any query, e.g., keywords, topics, channels, persons, and content sources, searched by the user 404, or user selection of predefined topics/categories. The channel creating unit 606 is configured to facilitate the user 404 to create one or more channels 406 each associated with at least one of the explicit and implicit interests. In other words, channel interests may be created by users in a hybrid fashion by taking advantage of both machine intelligence and user wisdom. As mentioned above, the channel creating unit 606 may be further configured to receive an input from the user 404 indicating one or more attributes associated with each channel, such as the name, tags, and description of the channel.

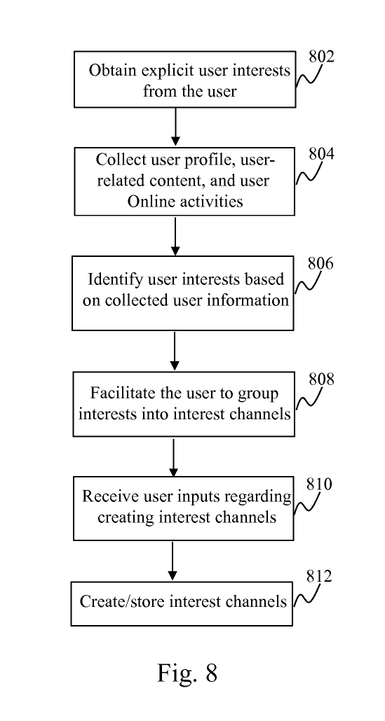

FIG. 8 is a flowchart of an exemplary process of the channel initiating module 408, according to an embodiment of the present teaching. Beginning at block 802, explicit user interests are obtained from the user. At block 804, user related information, including user profile, user-related content, and user online activities are collected, for example by, the interest discovering unit 602. Moving to block 806, implicit user interests are identified based on the user related information for example, by the interest discovering unit 602. The identification may be also based on users' known interests, trends, and users' social networks. At block 808, users are facilitated to group related interests into different channels for example, by the interest grouping unit 604. Moving to block 810, user inputs regarding creating interest channels, such as generating channel names, tags, and descriptions, are received. At block 812, interest channels are created and stored.

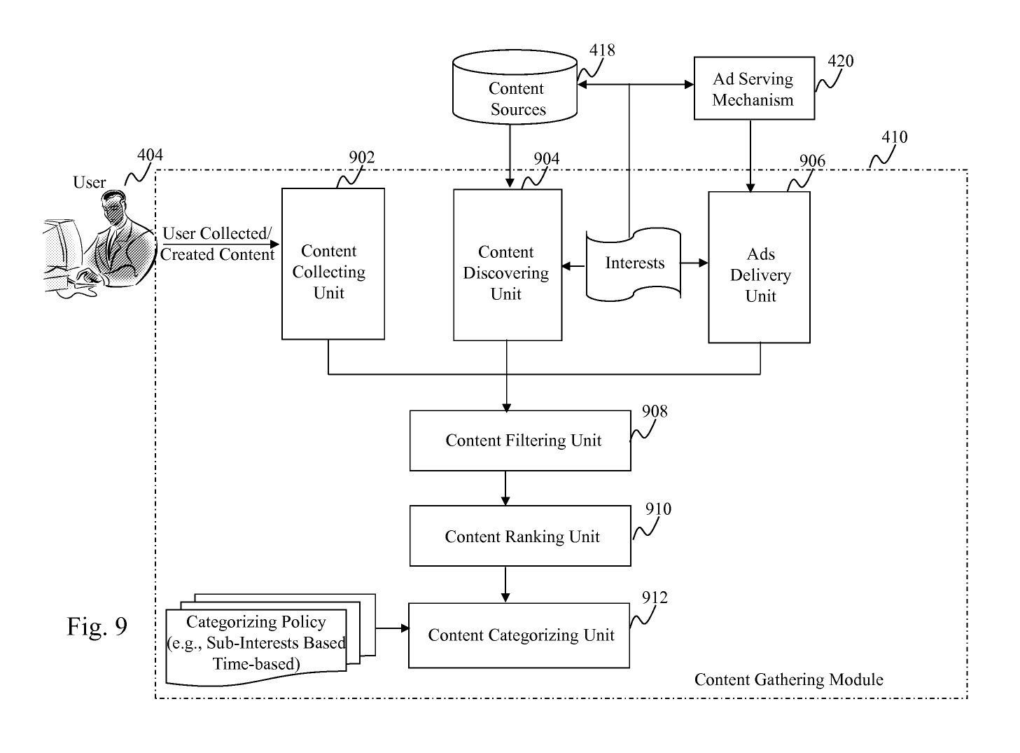

FIG. 9 is a system diagram for an exemplary content gathering module 410 of the system for facilitating users to obtain content, according to an embodiment of the present teaching. The content gathering module 410 in this example includes a content collecting unit 902, a content discovering unit 904, an advertisement delivery unit 906, a content filtering unit 908, a content ranking unit 910, and a content categorizing unit 912. The content collecting unit 902 is responsible for facilitating the user 404 to save and create content in the channels. For example, when the user 404 consumes content in the channels, they may simply save them in the channels. When the user 404 consumes content out of the system, they also may save content into the channels with any suitable extension tools. The content discovering unit 904 is configured to fetch content from content sources 418 based on the interests associated with each channel. The advertisement delivery unit 906 is configured to deliver advertisements from advertisement serving mechanism 420 based on the interests associated with each channel.

The content gathered through various means is combined and fed into the content filtering unit 908. As duplicated content may be gathered from different sources, the content filtering unit 908 is configured to filter out the duplicated content to ease the information overload problem. In addition, the content filtering may be performed according to any suitable criteria. In one example, outdated content over a threshold time period may be filtered out. In another example, repetitive information may be removed by the content filtering unit 908. The content ranking unit 910 is responsible for ranking the gather content based on, for example, relevance between each piece of content and the interest associated with the channel. Again, any other suitable criteria may be applied to rank the content, such as timeliness, location, importance, or any combination thereof. The content categorizing unit 912 in this example is configured to categorize the content based on a predefined categorizing policy. For example, as each channel may be associated with multiple interests, the content in each channel may be further categorized based on the sub-interests. In other examples, the content may be categorized based on, for example, time or location.

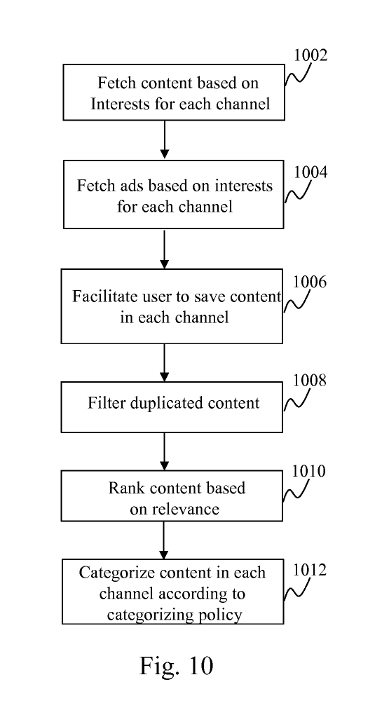

FIG. 10 is a flowchart of an exemplary process of the content gathering module 410, according to an embodiment of the present teaching. Starting from block 1002, content is fetched from various content sources based on associated interests for each channel. At block 1004, advertisements are fetched based on associated interests for each channel. Moving to block 1006, users are facilitated to save content in each channel. The content may be created or consumed by the users. Duplicated content is removed at block 1008, and the remaining content is ranked based on relevance at block 1010 in order to ease the information overload problem. At block 1012, content is categorized in each channel according to a predefined categorizing policy to further organize the content.

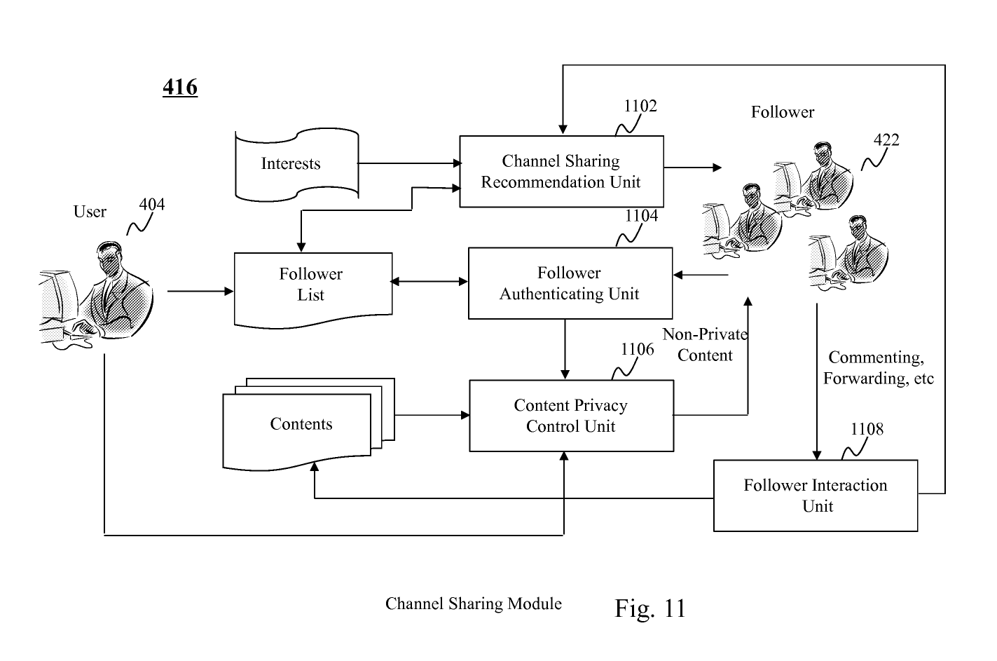

FIG. 11 is a system diagram for an exemplary channel sharing module 416 of the system for facilitating users to obtain content, according to an embodiment of the present teaching. The channel sharing module 416 in this example includes a channel sharing recommendation unit 1102, a follower authenticating unit 1104, a content privacy control unit 1106, and a follower interaction unit 1108. The channel sharing recommendation unit 1102 is configured to identify other users who may be interested in the channels created by the user 404 (channel owner). The identification may be achieved by, for example, analyzing the explicit and implicit interests of the potential followers and the social relationship between the channel owner and the potential followers. Once identified, the channels may be recommended to the potential followers to follow. It is understood that, the potential followers may find the channels they are interested in by themselves and send requests to the channel owner to follow. Once the potential followers are confirmed by the channel owner through the follower authenticating unit 1104, they become authorized followers 422 and are saved in the follower list. The content privacy control unit 1106 in this example is configured to set the privacy level for each piece of content in the channel. To protect user privacy, only non-private content may be viewed by the followers 422. Along with the non-private content, the followers 422 may interact with the content by, for example, commenting, forwarding, etc., through the follower interaction unit 1108.

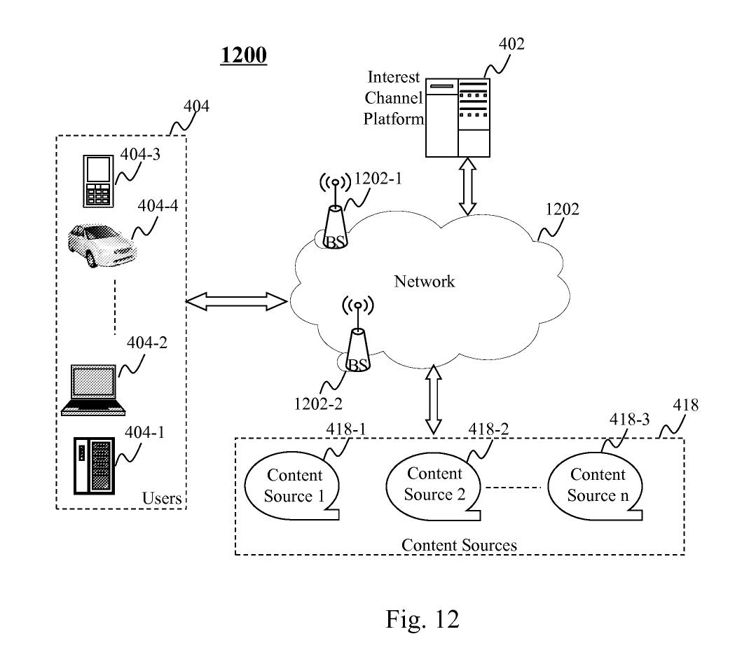

FIG. 12 depicts an exemplary networked environment in which the present teaching is applied, according to an embodiment of the present teaching. The exemplary system 1200 includes the interest channel platform 402, users 404, a network 1202, and content sources 418. The network 1202 may be a single network or a combination of different networks. For example, the network 1202 may be a local area network (LAN), a wide area network (WAN), a public network, a private network, a proprietary network, a Public Telephone Switched Network (PSTN), the Internet, a wireless network, a virtual network, or any combination thereof. The network 1202 may also include various network access points, e.g., wired or wireless access points such as base stations or Internet exchange points 1202-1, . . . , 1202-2, through which a data source may connect to the network in order to transmit information via the network.

Users 404 may be of different types such as users connected to the network 1202 via desktop connections (404-1), users connecting to the network 1202 via wireless connections such as through a laptop (404-2), a handheld device (404-3), or a built-in device in a motor vehicle (404-4). A user 404 may get access to the interest channel platform 402 via the network 1202. The content sources 418 include multiple content sources 418-1, 418-2, . . . , 418-3. A content source 418 may correspond to a web site hosted by an entity, whether an individual, a business, or an organization such as USPTO.gov, a content provider such as cnn.com and Yahoo.com, or a content feed source such as tweeter or blogs. The interest channel platform 402 may access information from any of the content sources 418-1, 418-2, . . . , 418-3. to fetch content for each interest channel.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the DCP processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

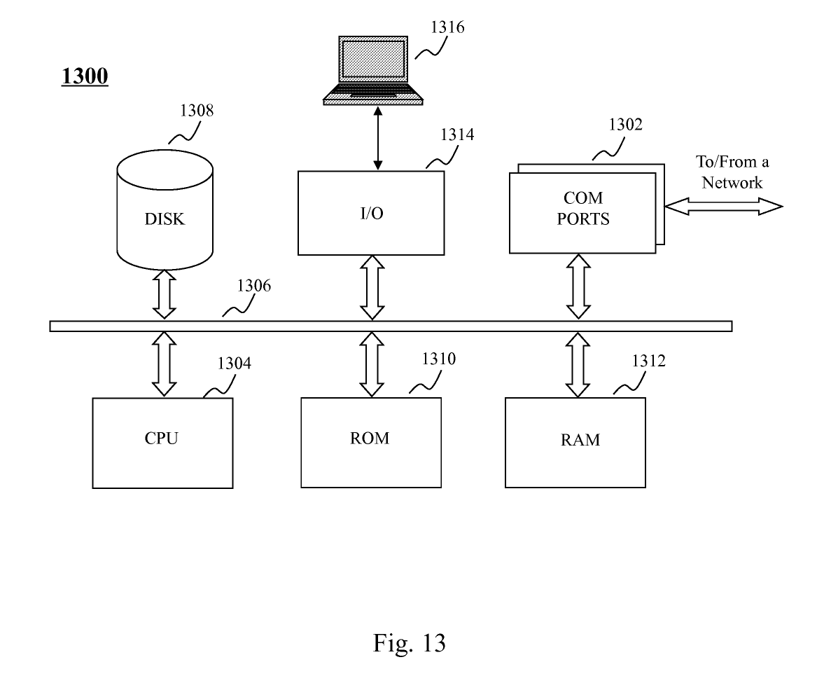

FIG. 13 depicts a general computer architecture on which the present teaching can be implemented and has a functional block diagram illustration of a computer hardware platform that includes user interface elements. The computer may be a general-purpose computer or a special purpose computer. This computer 1300 can be used to implement any components of the architecture as described herein. Different components of the system 400 can all be implemented on one or more computers such as computer 1300, via its hardware, software program, firmware, or a combination thereof. Although only one such computer is shown, for convenience, the computer functions relating to online advertising may be implemented in a distributed fashion on a number of similar platforms, to distribute the processing load.

The computer 1300, for example, includes COM ports 1302 connected to and from a network connected thereto to facilitate data communications. The computer 1300 also includes a central processing unit (CPU) 1304, in the form of one or more processors, for executing program instructions. The exemplary computer platform includes an internal communication bus 1306, program storage and data storage of different forms, e.g., disk 1308, read only memory (ROM) 1310, or random access memory (RAM) 1312, for various data files to be processed and/or communicated by the computer, as well as possibly program instructions to be executed by the CPU 1304. The computer 1300 also includes an I/O component 1314, supporting input/output flows between the computer 1300 and other components therein such as user interface elements 1316. The computer 1300 may also receive programming and data via network communications.

Hence, aspects of the method for facilitating user to obtain content, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the computer-implemented method programming.

All or portions of the computer-implemented method may at times be communicated through a network such as the Internet or various other telecommunication networks. Such communications, for example, may enable loading of the computer-implemented method from one computer or processor into another. Thus, another type of media that may bear the elements of the computer-implemented method includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the computer-implemented method. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution. In addition, the components of the system as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine, each of which has at least one processor, storage, and a communication platform connected to a network for facilitating users to obtain content, comprising the steps of:
facilitating a user to create one or more channels each associated with an interest;
gathering content for each of the one or more channels based on the interest associated with the channel;
refining the content in each of the one or more channels based on an interaction between the user and the channel; and
presenting at least part of the content in each of the one or more channels to the user, wherein the presented content is determined based on relevance between each piece of content and the associated interest of the channel.

2. The method of claim 1, further comprising the step of:
facilitating one or more followers to follow the one or more channels based on the interests associated with the channels.

3. The method of claim 1, further comprising the step of:
facilitating one or more advertisers to deliver advertisements to the one or more channels based on the interests associated with the channels.

4. The method of claim 1, wherein the interest is defined by at least one of:
a keyword;
a topic;
a document;
a content source; and
a social role.

5. The method of claim 1, wherein the step of facilitating a user to create one or more channels comprises the steps of:
receiving an input from the user indicating one or more explicit interests;
collecting information related to the user; and
identifying one or more implicit interests based on the collected information related to the user.

6. The method of claim 5, wherein the input includes at least one of:
entering one or more keywords to describe a channel;
selecting one or more predefined topics;
selecting one or more topics which are automatically generated by a topical modeling approach;
selecting one or more predefined content sources for providing content to a channel;
following anther user's channel; and
labeling one or more documents for a channel.

7. The method of claim 5, wherein the information related to the user includes at least one of:
user profile;
user-related content; and
user online activities.

8. The method of claim 5, wherein the step of facilitating a user to create one or more channels further comprises the steps of:
facilitating the user to group the explicit and implicit interests into the one or more channels; and
receiving an input from the user indicating an attribute associated with each channel.

9. The method of claim 8, wherein the attribute includes at least one of:
channel name;
channel description;
channel tag; and
the user created the channel.

10. The method of claim 1, wherein the step of providing content to each of the one more channels comprises the steps of:
fetching content from one or more content sources based on the interest associated with each channel;
fetching advertisements from one or more advertisers based on the interest associated with each channel;
facilitating the user to save content in each channel; and
facilitating the user to create content in each channel.

11. The method of claim 10, wherein the step of providing content to each of the one more channels further comprises the steps of:
filtering out duplicated content in each channel;
ranking the content based on the relevance between each piece of content and the interest associated with each channel; and
categorizing the content in each channel according to a categorizing policy.

12. The method of claim 1, wherein the interaction between the user and the channel includes at least one of:
changing the interest associated with the channel;
changing the content in the channel;
changing the attribute associated with the channel; and
following a channel created by another user.

13. The method of claim 1, wherein the step of presenting at least part of the content includes the steps of:
updating the at least part of the content when the user accesses each channel; and
achieving the at least part of the content in each channel periodically such that the user can review the achieved content in each channel based on a timeline of achieving.

14. The method of claim 1, further comprising the step of:
connecting a plurality of channels created by different users to form an interest network, wherein the plurality of channels are associated with interests that are related to each other.

15. A system for facilitating users to obtain content comprising:
a channel initiating module configured to facilitate a user to create one or more channels each associated with an interest;
a content gathering module configured to gather content for each of the one or more channels based on the interest associated with the channel;
a content refining module configured to refine the content in each of the one or more channels based on an interaction between the user and the channel; and
a content presenting module configured to present at least part of the content in each of the one or more channels to the user, wherein the presented content is determined based on relevance between each piece of content and the associated interest of the channel.

16. The system of claim 15, further comprising a channel sharing module configured to facilitate one or more followers to follow the one or more channels based on the interests associated with the channels.

17. The system of claim 15, wherein the content gathering module is further configured to facilitate one or more advertisers to deliver advertisements to the one or more channels based on the interests associated with the channels.

18. The system of claim 15, wherein the interest is defined by at least one of:
a keyword;
a topic;
a document;
a content source; and
a social role.

19. The system of claim 15, wherein the channel initiating module is further configured to:
receive an input from the user indicating one or more explicit interests;
collect information related to the user; and
identify one or more implicit interests based on the collected information related to the user.

20. The system of claim 19, wherein the input includes at least one of:
entering one or more keywords to describe a channel;
selecting one or more predefined topics;
selecting one or more topics which are automatically generated by a topical modeling approach;
selecting one or more predefined content sources for providing content to a channel;
following anther user's channel; and
labeling one or more documents for a channel.

21. The system of claim 19, wherein the information related to the user includes at least one of:
user profile;
user-related content; and
user online activities.

22. The system of claim 19, wherein the channel initiating module is further configured to:
facilitate the user to group the explicit and implicit interests into the one or more channels; and
receive an input from the user indicating an attribute associated with each channel.

23. The system of claim 22, wherein the attribute includes at least one of:
channel name;
channel description;
channel tag; and
the user created the channel.

24. The system of claim 15, wherein the content gathering module is further configured to:
fetch content from one or more content sources based on the interest associated with each channel;
fetch advertisements from one or more advertiser based on the interest associated with each channel;
facilitate the user to save content in each channel; and
facilitate the user to create content in each channel.

25. The system of claim 24, wherein the content gathering module is further configured to:
filter out duplicated content in each channel;
rank the content based on the relevance between each piece of content and the interest associated with each channel; and
categorize the content in each channel according to a categorizing policy.

26. The system of claim 15, wherein the interaction between the user and the channel includes at least one of:
changing the interest associated with the channel;
changing the content in the channel;
changing the attribute associated with the channel; and
following a channel created by another user.

27. The system of claim 15, wherein the content presenting module is further configured to:
update the at least part of the content when the user accesses each channel; and
achieve the at least part of the content in each channel periodically such that the user can review the achieved content in each channel based on a timeline of achieving.

28. A machine-readable tangible and non-transitory medium having information recorded thereon for facilitating users to obtain content, wherein the information, when read by the machine, causes the machine to perform the following:
facilitating a user to create one or more channels each associated with an interest;
gathering content for each of the one or more channels based on the interest associated with the channel;
refining the content in each of the one or more channels based on an interaction between the user and the channel; and
presenting at least part of the content in each of the one or more channels to the user, wherein the presented content is determined based on relevance between each piece of content and the associated interest of the channel.

29. The medium of claim 28, further comprising the step of:
facilitating one or more followers to follow the one or more channels based on the interests associated with the channels.

30. The medium of claim 28, further comprising the step of:
facilitating one or more advertisers to deliver advertisements to the one or more channels based on the interests associated with the channels.

31. The medium of claim 28, wherein the step of facilitating a user to create one or more channels comprises the steps of:
receiving an input from the user indicating one or more explicit interests;
collecting information related to the user; and
identifying one or more implicit interests based on the collected information related to the user.

32. The medium of claim 31, wherein the step of facilitating a user to create one or more channels comprises the steps of:
facilitating the user to group the explicit and implicit interests into the one or more channels; and
receiving an input from the user indicating an attribute associated with each channel.

33. The medium of claim 28, wherein the step of providing content to each of the one more channels comprises the steps of:
fetching content from one or more content sources based on the interest associated with each channel;
fetching advertisements from one or more advertisers based on the interest associated with each channel;
facilitating the user to save content in each channel; and
facilitating the user to create content in each channel.

34. The medium of claim 33, wherein the step of providing content to each of the one more channels comprises the steps of:
filtering out duplicated content in each channel;
ranking the content based on the relevance between each piece of content and the interest associated with each channel; and
categorizing the content in each channel according to a categorizing policy.

35. The medium of claim 28, wherein presenting at least part of the content includes the steps of:
updating the at least part of the content when the user accesses each channel; and
achieving the at least part of the content in each channel periodically such that the user can review the achieved content in each channel based on a timeline of achieving.

36. The medium of claim 28, further comprising the step of:
connecting a plurality of channels created by different users to form an interest network, wherein the plurality of channels are associated with interests that are related to each other.

37. A method implemented on at least one machine, each of which has at least one processor, storage, and a communication platform connected to a network for facilitating users to obtain content, comprising the steps of:
receiving an input from the user indicating one or more explicit interests;
collecting information related to the user;
identifying one or more implicit interests based on the collected information related to the user; and
facilitating the user to create one or more channels each associated with at least one of the explicit and implicit interests.

38. The method of claim 37, wherein the step of facilitating the user to create one or more channels comprises the steps of:
facilitating the user to group the explicit and implicit interests into the one or more channels; and
receiving an input from the user indicating an attribute associated with each channel.

39. The method of claim 37, wherein the input includes at least one of:
entering one or more keywords to describe a channel;
selecting one or more predefined topics;
selecting one or more topics which are automatically generated by a topical modeling approach;
selecting one or more predefined content sources for providing content to a channel;
following anther user's channel; and
labeling one or more documents for a channel.

40. The method of claim 37, wherein the information related to the user includes at least one of:
user profile;
user-related content; and
user online activities.

41. The method of claim 38, wherein the attribute includes at least one of:
channel name;
channel description;
channel tag; and
the user created the channel.

42. The method of claim 37, wherein the interest is defined by at least one of:
a keyword;
a topic;
a document;
a content source; and
a social role.

43. A system for facilitating users to obtain content comprising:
an interest grouping unit configured to receive an input from the user indicating one or more explicit interests;
an interest discovering unit configured to:
collect information related to the user, and
identify one or more implicit interests based on the collected information related to the user; and
a channel creating unit configured to facilitate the user to create one or more channels each associated with at least one of the explicit and implicit interests.

44. The system of claim 43, wherein
the interest grouping unit is further configured to facilitate the user to group the explicit and implicit interests into the one or more channels; and
the channel creating unit is further configured to receive an input from the user indicating an attribute associated with each channel.

45. The system of claim 43, wherein the input includes at least one of:
entering one or more keywords to describe a channel;
selecting one or more predefined topics;
selecting one or more topics which are automatically generated by a topical modeling approach;
selecting one or more predefined content sources for providing content to a channel;
following anther user's channel; and
labeling one or more documents for a channel.

46. The system of claim 43, wherein the information related to the user includes at least one of:
user profile;
user-related content; and
user online activities.

47. The system of claim 44, wherein the attribute includes at least one of:
channel name;
channel description;
channel tag; and
the user created the channel.

48. The system of claim 43, wherein the interest is defined by at least one of:
a keyword;
a topic;
a document;
a content source; and
a social role.

49. A machine-readable tangible and non-transitory medium having information recorded thereon for facilitating users to obtain content, wherein the information, when read by the machine, causes the machine to perform the following:
receiving an input from the user indicating one or more explicit interests;
collecting information related to the user;
identifying one or more implicit interests based on the collected information related to the user; and
facilitating the user to create one or more channels each associated with at least one of the explicit and implicit interests.

50. The medium of claim 49, wherein the step of facilitating the user to create one or more channels comprises the steps of:
facilitating the user to group the explicit and implicit interests into the one or more channels; and
receiving an input from the user indicating an attribute associated with each channel.

51. The medium of claim 49, wherein the input includes at least one of:
entering one or more keywords to describe a channel;
selecting one or more predefined topics;
selecting one or more topics which are automatically generated by a topical modeling approach;
selecting one or more predefined content sources for providing content to a channel;
following anther user's channel; and
labeling one or more documents for a channel.

52. The medium of claim 49, wherein the information related to the user includes at least one of:
user profile;
user-related content; and
user online activities.

53. The medium of claim 50, wherein the attribute includes at least one of:
channel name;
channel description;
channel tag; and
the user created the channel.

54. The medium of claim 49, wherein the interest is defined by at least one of:
a keyword;
a topic;
a document;
a content source; and
a social role.

55. A method implemented on at least one machine, each of which has at least one processor, storage, and a communication platform connected to a network for facilitating users to obtain content, comprising the steps of:
facilitating a plurality of users to create a plurality of channels each associated with an interest;
connecting at least some of the plurality of channels to form an interest network, wherein the connected channels are associated with interests that are related to each other; and
facilitating one or more advertisers to deliver advertisements to the interest network based on the associated interests.
